(19) United States
(12) Patent Application Publication
(10) Pub. No.: US 2026/0238352 A1
(43) Pub. Date: Aug. 13, 2026

(54) SYSTEM FOR DISTRIBUTING QUANTUM KEYS USING CORRECTION OF THE POLARIZATION OF PHOTONS

(71) Applicant: THALES, MEUDON (FR)

(72) Inventors: Raphaël AYMERIC, TOULOUSE (FR); Michel SOTOM, TOULOUSE (FR); Mathieu BERTRAND, TOULOUSE (FR)

(21) Appl. No.: 18/988,713

(22) Filed: Dec. 19, 2024

(30) Foreign Application Priority Data
Dec. 21, 2023 (FR) 2314815

(51) Int. Cl. H04B 10/85; H04B 10/077; H04J 14/02; H04J 14/06; H04L 9/08

(52) U.S. Cl. CPC H04B 10/85; H04B 10/0775; H04J 14/0307; H04J 14/06; H04L 9/0858

(57) ABSTRACT

A transmitter of a multiplexed signal through a transmission channel includes a generator of an initial quantum signal, of a first reference signal and of a second reference signal, an encoder having N optical channels including a selector for passing the initial signal to one of the channels, and a recombiner for generating the multiplexed signal, the multiplexed signal including first and second signals (R₁₁, R₁₂) for controlling first and second polarization-encoding values (P₁, P₂), respectively, and a quantum signal, determined based on the initial signal, encoded with an encoding value. The optical channels include two channels each including a unit for integrating a reference signal into the channel, each control signal being determined based on one of the reference signals delivered by the channel in question to the recombiner.

### CROSS-REFERENCE TO RELATED APPLICATION

This application claims priority to foreign French patent application No. FR 2314815, filed on Dec. 21, 2023, the disclosure of which is incorporated by reference in its entirety.

### FIELD OF THE INVENTION

The present invention generally relates to quantum telecommunication, and in particular to a transmitter for transmitting a multiplexed signal comprising a quantum signal, to a receiver for receiving a multiplexed signal comprising a quantum signal, and to a system comprising such a transmitter and receiver and the associated methods implemented.

### BACKGROUND

The main application of current quantum-telecommunication systems is to use quantum information theory to distribute a cryptographic key (or encryption key) between two remote telecommunication devices (i.e. two users), via specific quantum protocols, with the aim of subsequently encrypting the communications between these two devices in an ultra-secure manner. Such quantum protocols are generally designated by the acronym QKD, which stands for Quantum Key Distribution. The keys obtained via a QKD protocol are secret cryptographic keys having a security level higher than keys obtained using conventional protocols.

In the field of quantum cryptography, the remote users of a quantum communication system are conventionally named Alice (transmitting device) and Bob (receiving device). A QKD protocol comprises a step of transmitting encoded information on quantum particles, a step of receiving these particles and a step of reconciling the transmitter and receiver.

The transmitting step consists in encoding conventional information (0 or 1) on a qubit of the quantum particles, which are generally photons. A qubit corresponds to a degree of freedom of the quantum particle and may be the polarization of a photon. The receiving step consists in determining the state of the qubit of the received photons, to retrieve the encoded conventional information. In the reconciling step, the transmitting device and the receiving device communicate to correct potential transmission errors and generate a shared raw key. These devices, i.e. the transmitter and receiver, thus respectively convert the encoded information and the determined information (corresponding to their respective raw key) into an ultra-secure key allowing the confidentiality of their telecommunication exchanges to be increased.

Such a type of QKD protocol using the polarization of quantum particles as qubit requires the qubits to be encoded, transmission end, and measured, reception end, in at least two different and non-orthogonal polarization bases.

However, the polarization state of the quantum particles undergoes random rotations between their transmission and reception (i.e. during their propagation). These may be due to the birefringence of the various media traversed or indeed to a movement of the transmitting device with respect to the receiving device, such as a movement of a satellite (transmitter or receiver) with respect to a ground station in the case of communications one leg of which is through outer space.

To avoid such random rotations of polarization state, certain known QKD systems make provision to ensure the photons propagating through a transmission channel only propagate through free space (their polarization then remaining stable). However, in certain applications, it is necessary to use guided optical transmission as a transmission channel, for example in the case of propagation through a ground network or on board a satellite, in order to relax constraints on construction of the payload.

To compensate (or correct) for random rotations of polarization state, certain known systems use, at the start of the QKD protocol, a single polarization reference that allows the polarization rotations induced during propagation to be initially estimated, and the polarization of the transmitted photons to be aligned with the reception-end measurement bases. However, this single reference does not make it possible to correct for new polarization rotations after the initial estimating phase. Alternatively, other existing systems instead periodically generate reference signals in the encoding bases using the source of quantum signals, the reference signals therefore being time-division multiplexed with the qubits, this reducing the bandwidth of the system available for payload.

There is thus a need for an improved QKD system capable of correcting in real time for rotations of the polarization states used to encode and decode the qubits.

### SUMMARY OF THE INVENTION

To this end, a transmitter is provided that is configured to transmit a multiplexed signal through a transmission channel. The transmitter comprises:
a signal generator configured to generate an initial quantum signal, a first reference signal and a second reference signal,
a polarization encoder comprising a plurality of N optical channels, the polarization encoder further comprising:
an optical selector configured to select one of the optical channels and to pass the generated initial quantum signal to the selected optical channel, an optical recombiner configured to generate the multiplexed signal, the multiplexed signal comprising a first signal for controlling a first polarization-encoding value, a second signal for controlling a second polarization-encoding value, and a quantum signal encoded with one polarization-encoding value selected from a set of values containing at least the first polarization-encoding value and the second polarization-encoding value, the encoded quantum signal being determined based on the initial quantum signal delivered by the optical channel selected by the optical selector,

The optical channels comprise a first optical channel comprising a first integrating unit configured to integrate the first reference signal into the first optical channel and a second optical channel comprising a second integrating unit configured to integrate the second reference signal into the second optical channel, the first control signal being determined based on the first reference signal delivered by the first optical channel to the optical recombiner, and the second control signal being determined based on the second reference signal delivered by the second optical channel to the optical recombiner.

In embodiments, each optical channel of the polarization encoder may be associated with one polarization-encoding value of the set of values, and at least one of the optical channels may further comprise an optical element configured to modify the polarization of an optical signal passing through the optical channel depending on the associated encoding value.

In one embodiment, the transmitter may be a guided all-optical device, the optical channels of the polarization encoder being formed from polarization-maintaining fibers and/or integrated waveguides.

The present invention further provides a receiver configured to receive a multiplexed signal through a transmission channel, the multiplexed signal comprising an encoded quantum signal, a first signal for controlling a first polarization-encoding value and a second signal for controlling a second polarization-encoding value. The receiver comprises a beamsplitter configured to split the multiplexed signal into two signal components comprising one component of the first control signal and one component of the second control signal, each signal component passing through a processing chain associated with a polarization basis composed of at least one polarization state, respectively, one of the signal components further comprising the encoded quantum signal.

Each processing chain comprises a correcting device configured to determine the polarization state of an integrated control signal of the signal component passing through the chain, the correcting device further being configured to modify the polarization of the signal component so as to align the determined polarization state with respect to one of the at least one polarization state of the associated basis, each processing chain comprising a detecting module configured to measure the encoded quantum signal in at least one of the at least one polarization state of the associated basis.

In embodiments, for each processing chain, the correcting device may be configured to demultiplex the signal component with a view to selecting one of the control-signal components and routing it to a polarization-analyzing device comprising at least one detecting unit and configured to detect the selected component of the integrated control signal in one of the at least one polarization state of the associated basis.

According to certain aspects, in each processing chain, the correcting device may further comprise a processor configured to analyze the determined polarization state and to generate a servo-control signal applied to a module for correcting the polarization of the signal component.

In embodiments, the beamsplitter may be a symmetrical fiber-optic 50/50 optical Y-coupler, and the processing chains may be formed from polarization-maintaining fibers and/or single-mode optical fibers.

The embodiments of the invention thus provide a system for distributing quantum encryption keys, comprising a transmitter and a receiver.

In embodiments, the multiplexed signal may be a frequency-division multiplexed signal.

In one embodiment, the absolute value of the wavelength difference between the encoded quantum signal and the first and/or second integrated signal may be greater than or equal to a first minimum wavelength-difference value, and the absolute value of the wavelength difference between the first control signal and the second control signal may be greater than or equal to a second minimum wavelength-difference value.

The present invention in addition provides a transmitting method for transmitting a multiplexed signal through a transmission channel, the method comprising the steps of:
generating an initial quantum signal, a first reference signal and a second reference signal,
selecting one optical channel from a plurality of N optical channels, the optical channels comprising a first optical channel and a second optical channel, and passing the generated initial quantum signal to the selected optical channel,
inserting the first reference signal into the first optical channel and the second reference signal into the second optical channel,
forming the multiplexed signal, the multiplexed signal comprising a first signal for controlling a first polarization-encoding value, a second signal for controlling a second polarization-encoding value, and a quantum signal encoded with one polarization-encoding value selected from a set of values containing at least the first polarization-encoding value and the second polarization-encoding value, the encoded quantum signal being determined based on the initial quantum signal delivered by the selected optical channel, the first control signal being determined based on the first reference signal delivered by the first optical channel, and the second control signal being determined based on the second reference signal delivered by the second optical channel.

The present invention also provides a method for receiving a multiplexed signal through a transmission channel, the multiplexed signal comprising an encoded quantum signal, a first signal for controlling a first polarization-encoding value and a second signal for controlling a second polarization-encoding value, the method comprising the step of splitting the multiplexed signal into two signal components comprising one component of the first control signal and one component of the second control signal, each signal component passing through a processing chain associated with a polarization basis composed of at least one polarization state, respectively, one of the signal components further comprising the encoded quantum signal.

### The Receiving Method Further Comprises Iterative Steps of:

determining the polarization state of an integrated control signal of the signal component passing through the chain, and
modifying the polarization of the signal component so as to align the determined polarization state with respect to one of the at least one polarization state of the associated basis.

The receiving method comprises the step of determining the encoded quantum signal in at least one of the at least one polarization state of the associated basis.

Embodiments of the invention thus make it possible to correct polarization rotations of the qubits (defined in at least two different and non-orthogonal polarization bases) transmitted between a transmitter and receiver of a quantum signal with a view to establishing a quantum key.

In particular, embodiments of the invention provide a signal transmitter allowing robust integration of polarization reference signals into a quantum communication signal.

Such references may be generated at any power, independently of the generation of the qubits, to form an effective solution that is accessible in terms of hardware complexity. The guided optics transmitter, according to the embodiments of the invention, advantageously has small bulk and weight, and an optimized footprint and robustness. Moreover, frequency-division multiplexing such references with the qubits makes it possible to maintain a high bandwidth for transmission of payload data (i.e. qubits).

The receiver according to the embodiments of the invention makes it possible to correct in real time for polarization rotations undergone by the qubits before detection. Such a receiver in particular makes it possible to analyze the qubits and the polarization reference signals independently, in order to best align the polarization of the qubits with the measurement bases of the receiver.

### BRIEF DESCRIPTION OF THE DRAWINGS

Other features, details and advantages of the invention will become apparent on reading the description given with reference to the appended drawings, which are given by way of example.

FIG. 1 is a schematic showing a quantum communication system, according to embodiments of the invention.

FIG. 2 is a schematic showing a polarization encoder of a transmitter, according to embodiments of the invention.

FIG. 3 is a schematic showing a polarization encoder of a transmitter, according to embodiments of the invention.

FIG. 4 is a schematic showing a polarization encoder of a transmitter, according to embodiments of the invention.

FIG. 5 is a schematic showing an optical selector of a polarization encoder, according to embodiments of the invention.

FIG. 6 is a schematic showing a signal generator of a transmitter, according to embodiments of the invention.

FIG. 7 is a schematic showing a receiver of a quantum communication system, according to embodiments of the invention.

FIG. 8 is a schematic showing a receiver of a quantum communication system, according to embodiments of the invention.

FIG. 9 is a schematic showing a receiver of a quantum communication system, according to embodiments of the invention.

FIG. 10 shows a module for detecting an integrated control signal, used in a processing chain of a receiver, according to embodiments of the invention.

FIG. 11 is a schematic showing a module for detecting an integrated control signal, used in a processing chain of a receiver, according to embodiments of the invention.

FIG. 12 is a schematic showing a module for detecting a quantum signal, used in a processing chain of a receiver, according to embodiments of the invention.

FIG. 13 is a flowchart showing a method for transmitting a signal comprising a quantum signal produced by a transmitter, according to embodiments of the invention.

FIG. 14 is a flowchart of a method for transmitting a signal comprising a quantum signal produced by a receiver, according to embodiments of the invention.

Identical references have been used in the figures to denote identical or similar elements. For the sake of clarity, the elements that are shown are not to scale.

### DETAILED DESCRIPTION

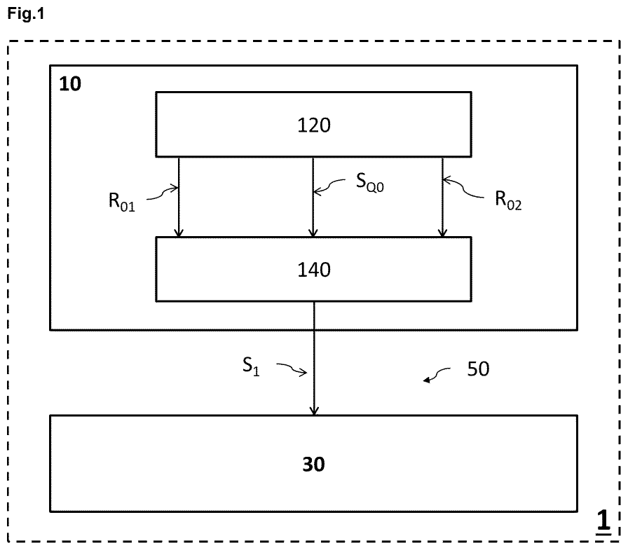

FIG. 1 schematically shows a quantum communication system 1 comprising two communicating devices 10 and 30 capable of communicating with each other, according to embodiments of the invention. Both devices comprise a transmitter 10 (or transmitting device), also called ‘Alice’, and a receiver 30 (or receiving device), also called ‘Bob’.

The quantum communication system 1 may for example be used in the space-technology field and comprise a transmitter 10 (or vice versa a receiver 30) installed on board a satellite while the receiver 30 (or vice versa the transmitter 10) is a terrestrial module (i.e. a module on the ground). As a variant, the system 1 may be used in an application where at least one of the transmitting device 10 and receiving device 30 is an avionic device. Furthermore, the system 1 may be used in an application where at least one of the transmitting device 10 and receiving device 30 is a guided all-optical device, potentially integrated into a fiber-optic network on the ground. The transmitting device 10 and/or the receiving device 30 may be stationary or in motion with respect to the other device with which it is communicating (30 or 10 according to the circumstances).

The transmitter 10 comprises a signal generator 120 and a polarization encoder 140.

As used here, an ‘optical signal’ (also simply called a “signal”) results from one or more pulses of coherent light generated by an optical source, such as a laser beam for example. A laser beam may in particular be characterized by its pulse rate f and by a laser pulse (i.e. the signal) defined by its frequency ω, its intensity I, its polarization P and its phase. The ‘frequency ω’ of the laser beam designates the ‘optical frequency of the laser pulse multiplied by 2π’ and is defined as a function of the wavelength of the beam λ, such that

$$λ \times \frac{ω}{2 π} = 𝒸 ,$$

c designating the speed of light.

A ‘quantum signal’ may refer to a pulsed optical signal containing on average less than one photon per pulse. In the context of this invention, a transmitted quantum signal may refer to a pulsed optical signal containing a low number of photons per pulse. Measurement of a quantum signal delivers a photon detection measurement dependent on a “probability of detection” of the photon.

The transmitter 10 is configured to generate and transmit, through a transmission channel 50, a multiplexed optical signal (also called the ‘multiplexed optical signal’ or the ‘multiplexed communication signal’), denoted S₁. The multiplexed signal S₁ comprises a quantum signal, denoted S_{Q1}, the payload information being encoded on the polarization of the constituent pulses of the quantum signal. The polarization of a photon of the encoded quantum signal S_{Q1} is selected from a set P of states (also called the ‘encoding states’ or ‘encoding values’) comprising at least a first polarization-encoding value, denoted P₁, and a second polarization-encoding value, denoted P₂. The multiplexed signal S₁ also comprises a first integrated optical signal R₁₁ for controlling the first polarization-encoding value P₁ (also called the ‘first control signal’ R₁₁) and a second integrated optical signal R₁₂ for controlling the second polarization-encoding value P₂ (also called the ‘second control signal’ R₁₂).

The transmission channel 50 may for example be free space or a fiber-optic device for conveying information, for example a device employing fiber-optic elements for the purpose of communication, depending on the field of application of the invention.

The receiver 30 is configured to receive, via the transmission channel 50, the multiplexed signal S₁, i.e. the signal transmitted by the transmitter 10, and to estimate the received control signals, this resulting in estimated control signals R₃₁ and R₃₂. The receiver 30 is further configured to estimate the received quantum signal, this resulting in an estimated received quantum signal S_{Q3}, based on the estimated control signals R₃₁ and R₃₂.

According to one aspect of the invention, the transmitter 10 and the receiver 30 are configured to establish (i.e. determine) a quantum encryption key, using the polarization-encoded quantum signal S_{Q1} and the estimated received quantum signal S_{Q3}. The system 1 may thus be a system for distributing quantum encryption keys configured to carry out QKD within a spatial or terrestrial communication service, with the aim of ensuring the security of some or all of the communications exchanged between the transmitter and receiver.

In embodiments, the quantum communication system 1 may comprise a plurality of distinct receivers 30. In this case, the transmitter 10 may be configured to generate and transmit to at least two of the distinct receivers, for example sequentially, a specific multiplexed optical signal. The system 1 may thus be configured to carry out QKD between these distinct receivers.

The multiplexed signal S₁ is generated, via the polarization encoder 140 (also called the ‘polarization-encoding module’), from an initial quantum signal, denoted S_{Q0}, from a first reference signal, denoted R₀₁, and from a second reference signal, denoted R₀₂. The initial quantum signal S_{Q0} and the reference signals R₀₁ and R₀₂ are generated by the signal generator 120, as shown in FIG. 1.

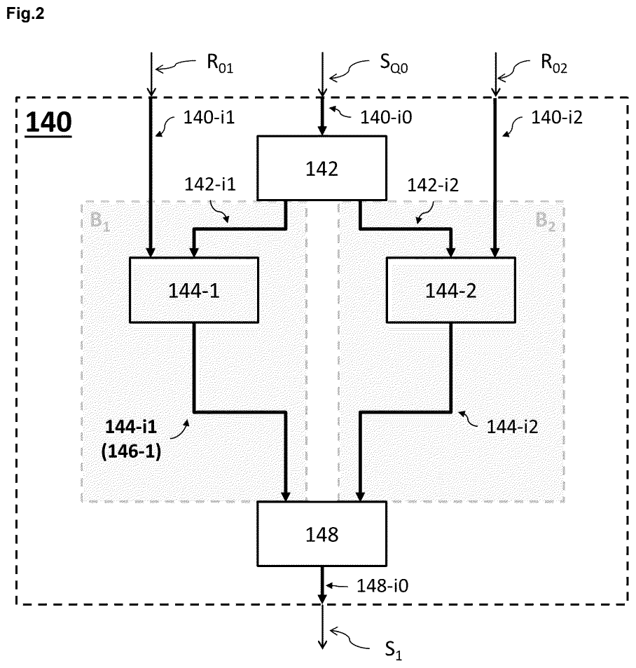

FIGS. 2, 3 and 4 schematically show the polarization encoder 140 of the transmitter 10, configured to form the multiplexed signal S₁, according to embodiments of the invention.

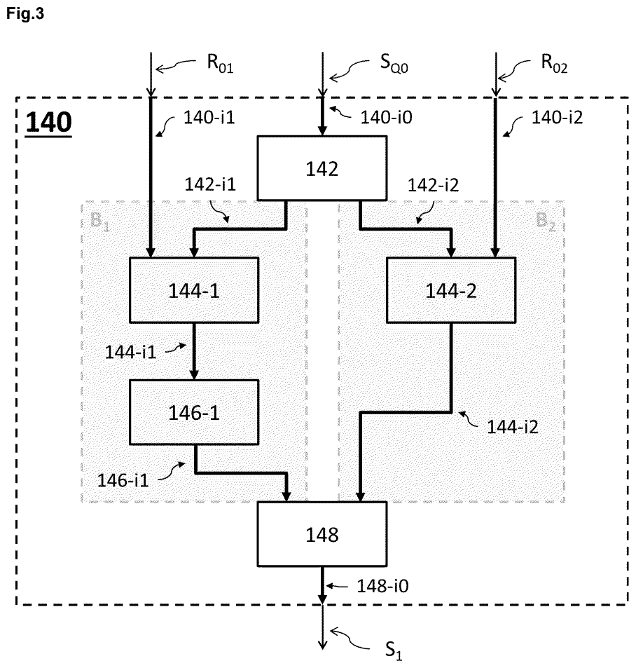

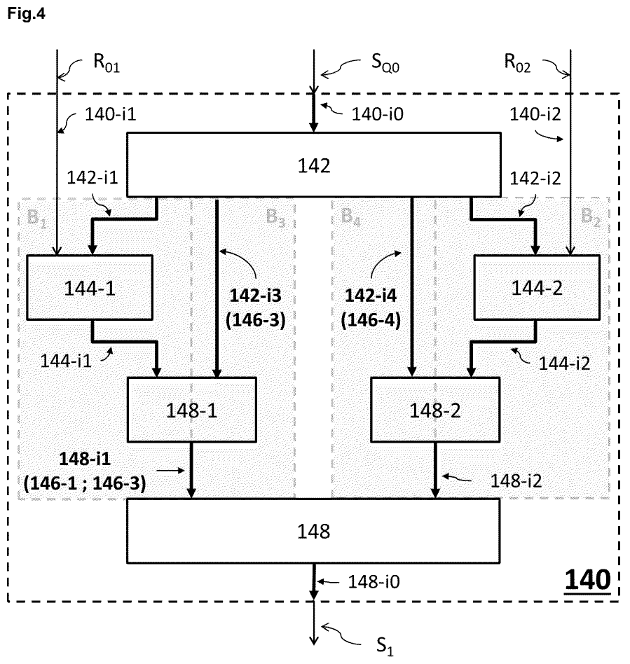

The polarization encoder 140 may take the form of an optical instrument (such as an optical interferometer for example) having a plurality of N polarization-encoding optical arms Bₙ (also called ‘optical channels’). The index ‘n’ is the index of the nth optical arm of the polarization encoder 140 and is an integer between 1 and N, the value of N being greater than or equal to 2. In particular, the value of N may be an integer equal to 2, as in the examples of FIGS. 2 and 3, or an integer equal to 4, as in the example of FIG. 4. The polarization encoder 140 thus comprises at least one first optical arm B₁ (i.e. the ‘first optical channel B₁’) and a second optical arm B₂ (i.e. the ‘second optical channel B₂’).

The polarization encoder 140 comprises an optical selector 142 (also called the ‘optical path-selecting unit’, ‘optical selector’, ‘optical router’ or ‘optical switch’) and an optical recombiner 148 (also called ‘optical path-recombining unit’ or ‘beam-recombining unit’) configured to deliver the multiplexed signal S₁ transmitted by the transmitter 10. The various optical arms Bₙ extend between the optical selector 142 and the optical recombiner 148.

The optical selector 142 of the polarization encoder 140 is configured to receive the initial quantum signal S_{Q0} and to pass it (i.e. route it) to one of the optical arms Bₙ. The polarization encoder 140 may thus be configured to control the optical selector 142, i.e. to select the direction of propagation of the initial quantum signal S_{Q0} to one of the optical arms Bₙ, in response to a command signal S_{C14}. For example and non-limitingly, such a command signal S_{C14} may be an electrical or radio-frequency signal, constructed from a number N of command values, each command value corresponding to one polarization-encoding optical arm Bₙ. Thus, the command signal S_{C14} may comprise a plurality of values selected, randomly for example, from the predefined command values.

The polarization encoder 140 also comprises a first signal-integrating unit 144-1 and a second signal-integrating unit 144-2. The first signal-integrating unit 144-1 is arranged on the first optical arm B₁ of the encoder 140 and is configured to insert (i.e. incorporate) the first reference signal R₀₁ into the first optical arm B₁. The second signal-integrating unit 144-2 is arranged on the second optical arm B₂ of the encoder 140 and is configured to insert the second reference signal R₀₂ into the second optical arm B₂.

In other words, in response to a specific command signal S_{C14}, the optical selector 142 may be configured to pass to the first optical arm B₁. The first integrating unit 144-1 may thus be configured to multiplex (or combine) the first reference signal R₀₁ with any signal conveyed by the first optical arm B₁ (i.e. the initial quantum signal if it was passed to the first optical arm B₁ by the optical selector 142). If the initial quantum signal S_{Q0} is not passed to the first optical arm B₁, the optical selector 142 may be configured to pass the signal S_{Q0} to the second optical arm B₂. The second signal-integrating unit 144-2 may thus be configured to multiplex the second reference signal R₀₂ with any signal conveyed by the second optical arm B₂ (i.e. the quantum signal if it was rather passed to the second optical arm B₂ by the optical selector 142 and not to the first optical arm B₁).

In embodiments where the polarization encoder 140 has a number N of optical arms strictly greater than 2, in response to a specific command signal S_{C14}, the optical selector 142 may further be configured to pass the initial quantum signal S_{Q0} to an optical arm Bₙ that is distinct from the first optical arm B₁ and from the second optical arm B₂.

For example, for a polarization encoder 140 comprising two polarization-encoding optical arms B₁ and B₂, as for example shown in FIGS. 2 and 3, if the optical selector 142 passes the initial quantum signal S_{Q0} to the first optical arm B₁, the resulting signal output from the first signal-integrating unit 144-1 results from optical multiplexing of the first reference signal R₀₁ and of the initial quantum signal S_{Q0}, which was routed to the first optical arm B₁, whereas the resulting signal output from the second signal-integrating unit 144-2 comprises only the second reference signal R₀₂. Alternatively, if the optical selector 142 passes the initial quantum signal S_{Q0} to the second optical arm B₂, the resulting signal output from the first signal-integrating unit 144-1 comprises only the first reference signal R₀₁, whereas the resulting signal output from the second signal-integrating unit 144-2 results from optical multiplexing of the second reference signal R₀₂ and of the initial quantum signal S_{Q0}.

According to another example, for a polarization encoder 140 comprising four polarization-encoding optical arms B₁, B₂, B₃ and B₄, as shown in FIG. 4, if the optical selector 142 passes the initial quantum signal S_{Q0} to the first or to the second optical arm B₁ or B₂, then no signal is conveyed by (i.e. propagates through) the third and fourth optical arms B₃ and B₄. Furthermore, no signal is delivered by the third and fourth optical arms B₃ and B₄ to the optical recombiner 148. Alternatively, if the optical selector 142 passes the initial quantum signal S_{Q0} to the third or fourth optical arm B₃ or B₄, the resulting signals output from the first signal-integrating unit 144-1 and the second signal-integrating unit 144-2 comprise only the first reference signal R₀₁ and the second reference signal Roz, respectively. In this case, a quantum signal, determined based on the initial quantum signal S_{Q0}, is delivered by the third optical arm B₃ (or by the fourth optical arm B₄) to the optical recombiner 148, and no signal is delivered by the fourth optical arm B₄ (or by the third optical arm B₃, respectively), depending on the optical channel selected by the optical selector 142.

Each optical arm Bₙ of the polarization encoder 140 is associated with one beam-specific polarization-encoding value Pₙ. The set P of possible variables thus contains the plurality of N encoding variables Pₙ, which are distinct from one another. Advantageously, each command value of the signal S_{C14} of the optical selector 142, corresponding to one polarization-encoding optical arm Bₙ, also corresponds to one polarization-encoding state Pₙ. The command signal S_{C14} may thus make it possible to form at least part of a so-called raw quantum encryption key to be shared between the transmitter 10 and the receiver 30 in the system 1. The payload information is then conveyed by the quantum signal (i.e. the quantum particles) modulated with the encoding states Pₙ through each of the optical arms of the transmitter Alice.

In such embodiments, an optical arm Bₙ of the polarization encoder 140 may further comprise an optical element 146-n (also called the ‘polarization-modifying unit’ or ‘encoding unit’) configured to modify (or encode) the polarization of an optical signal passing through the optical arm Bₙ depending on the encoding value Pₙ associated with said optical arm.

For example, the polarization encoder 140 may comprise at least one first optical element 146-1 placed on the first optical arm B₁, between the output of the first signal-integrating unit 144-1 and the input of the optical recombiner 148, so as to modify the polarization of the resulting signal output from the first signal-integrating unit 144-1 (i.e. the signal corresponding to the result of multiplexing the first reference signal R₀₁ and the initial quantum signal S_{Q0}, or only the signal corresponding to the first reference signal R₀₁), depending on the first polarization-encoding value P₁ associated with the first optical arm B₁.

Advantageously, the initial quantum signal S_{Q0}, the first reference signal R₀₁, and the second reference signal Roz, generated by the signal generator 120, may initially be characterized by the same polarization P₀ at the input of the polarization encoder 140. For example and non-limitingly, such an initial polarization P₀ may be a linear polarization, of type H, i.e. horizontal (or alternatively of type V, i.e. vertical). In this case, a polarization-encoding value Pₙ of an optical arm Bₙ comprising an encoding unit 146-n may correspond to a linear polarization of type V (or of type H, respectively). Thus, an optical element 146-n may be configured to rotate through an angle of ±90° (i.e. to apply a rotation of +90° to) the initial polarization P₀ of an optical signal delivered as output from the optical selector 142, and/or as output from a signal-integrating unit (144-1 and/or 144-2) on the optical arm Bₙ. Such a polarization-encoding value Pₙ may moreover correspond to a linear polarization of type D, i.e. diagonal (or of type A, i.e. anti-diagonal). In this case, the optical element 146-n may be configured to rotate through an angle of ±45° (i.e. to apply a rotation of ±45° to) the initial polarization P₀ of an optical signal passing through the optical arm Bₙ at the output of the optical selector 142, and/or at the output of a signal-integrating unit (144-1 and/or 144-2).

In embodiments, the polarization encoder 140 may be a guided all-optical device. As used here, the term ‘guided all-optical device’ refers to an optical device the optical signal-transmitting channels of which consist of optical fibers and/or so-called integrated waveguides typically used in integrated photonics. In this case, an encoding unit 146-n may comprise one or more polarization-rotating transmitting means configured to apply an angular rotation to the polarization of an optical signal delivered as output from a signal-integrating unit (144-1 and/or 144-2) or to the initial quantum signal output from the optical selector 142, on the optical arm Bₙ.

For example and non-limitingly, such an encoding unit 146-n may take the form of a fiber referred to as the ‘polarization-rotating fiber’ and corresponding, in particular, to a polarization-maintaining fiber (PMF) having a stress axis that suitably modifies (or rotates) the polarization of the signal passing through the fiber, to an angle predetermined by the initial polarization of said signal and the encoding value Pₙ associated with the optical arm Bₙ. Such embodiments are illustrated in FIGS. 2 and 4. In particular, in FIG. 2, the transmitting means 144-i1 corresponds to the encoding unit 146-1 of the optical arm B₁, while, in FIG. 4, the transmitting means 148-i1 corresponds to the encoding unit 146-1 of the optical arm B₁ and moreover the transmitting means 142-i4 corresponds to the encoding unit 146-4 of the optical arm B₄.

Advantageously, the polarization encoder 140 may comprise one or more intermediate optical recombiners allowing the structure of the optical instrument to be simplified by combining (or rationalizing) certain optical functions. For example, in FIG. 4, the polarization encoder 140 comprises intermediate optical recombiners 148-1 and 148-2 arranged upstream of the optical recombiner 148 delivering the multiplexed signal S₁. In this case, an encoding unit 146-n may be composed of a plurality of polarization-rotating fibers, taking the form of polarization-maintaining fibers (PMFs) each having a stress axis and the resultant of which is set to the predetermined polarization rotation angle by the encoding value Pₙ associated with the optical arm Bₙ. This embodiment is illustrated by the arrangement of FIG. 4, which uses a combination of transmitting means 142-i3 and 148-i1 corresponding to the encoding unit 146-3 of the optical arm B₃. Such intermediate optical recombiners make it possible to reduce the total number of polarization-rotating transmitting means required to encode the various encoding values Pₙ to be implemented by the transmitter 10, via combination of transmitting means to form resulting encoding units.

In the example illustrated in FIG. 4, each optical arm B₁, B₂, B₃ or B₄ extends from the optical selector 142 to the optical recombiner 148, the optical arms B₁ and B₃, and the optical arms B₂ and B₄, respectively having common optical paths 148-i1 and 148-12. By way of illustration, the transmitting means 142-i3 and 142-i4, shown in FIG. 4, which extend between the optical selector 142 and the input of the intermediate optical recombiners 148-1 and 148-2, without intermediate elements, may be configured to rotate through an angle of +90° the initial polarization P₀ of the quantum signal passing through the optical arms B₃ and B₄, respectively. Furthermore, the transmitting means 148-i1, arranged between the output of the first intermediate optical recombiner 148-1 and the input of the optical recombiner 148, may be configured to rotate through an angle of +45° the polarization of the resulting signal tracing the optical path common to the optical arms B₁ and B₃ (i.e. the signal comprising at least the first reference signal R₀₁). In this example, the polarization-encoding value P₁ of the optical arm B₁ may correspond to a polarization rotation of +45°, the polarization-encoding value P₃ of the optical arm B₃ may correspond to a polarization rotation of −45°, and the polarization-encoding value P₄ of the optical arm B₄ may correspond to a polarization rotation of 90°.

Alternatively, in embodiments where the polarization encoder 140 is a device comprising at least one means for transmitting a signal through free space, an integrating unit (144-1; 144-2) based on one or more dichroic filters may be employed. Furthermore, an encoding unit 146-n based on one or more thin polarization-rotating wave plates (or retarders), such as a half-wave plate and/or a quarter-wave plate, may be employed, as shown in FIG. 3.

In embodiments, a polarization-encoding value Pₙ associated with the optical arm Bₙ may correspond directly to the initial polarization P₀. In this case, such an optical arm of the polarization encoder 140 may be arranged so as not to modify the polarization of the optical signal or signals passing through it (i.e. polarization rotation of) 0°. The optical arm Bₙ of the polarization encoder 140 may thus comprise one or more polarization-maintaining transmitting means configured to transmit the one or more optical signals of the resulting signal output from the signal-integrating unit 144-n to the input of the optical recombiner 148, or the initial quantum signal output from the optical selector 142 to the input of the optical recombiner 148. Such transmitting means may for example be a PMF, if the polarization encoder 140 is a guided all-optical device.

By way of illustration, as shown in FIGS. 2, 3 and 4, the second polarization-encoding value P₂ of the signal resulting from the second optical arm B₂, at the input of the optical recombiner 148 (i.e. multiplexing of the second reference signal R₀₂ and of the initial quantum signal S_{Q0}, or only the second reference signal R₀₂) may be characterized by the initial polarization P₀, i.e., for example, and non-limitingly, the initial linear polarization of type H (or of type V). In this case, the transmitting means 144-12 and 148-12, arranged between the signal-integrating unit 144-n and the input of the optical recombiner 148 may be PMFs.

In embodiments, the optical recombiner 148 and optionally the one or more intermediate optical recombiners (148-1, 148-2) of the polarization encoder 140 may also be optical couplers (for example fiber-optical Y-couplers) configured to combine resulting signals delivered by optical arms Bₙ of the encoder 140. Such optical couplers may in particular be polarization-maintaining couplers. In certain embodiments, the optical recombiner 148 may be the telescope of the satellite on board of which the transmitter 10 is mounted.

The first polarization-modified reference signal R₀₁ passing through the first optical arm B₁ (i.e. the polarization-modifying unit 146-1) is encoded with the first encoding value P₁ to form, at the input of the optical recombiner 148, the first signal R₁₁ for controlling the first polarization-encoding value P₁. Equivalently, the second reference signal R₀₂ passing through the second optical arm B₂, whether polarization-modified or polarization-unmodified, is then said to be “encoded” with the second encoding value P₂ to form, at the input of the optical recombiner 148, the second signal R₁₂ for controlling the second polarization-encoding value P₂. The initial quantum signal S_{Q0} passing through any one of the optical arms Bₙ of the polarization encoder 140, whether polarization-modified or polarization-unmodified, is then said to be “encoded” with the encoding value Pₙ to form, at the input of the optical recombiner 148, the encoded quantum signal S_{Q1}.

In embodiments where the polarization encoder 140 is a guided all-optical device, the polarization encoder 140 may further comprise a plurality of optical fibers configured to transmit the one or more optical signals between the various units of the encoder (and in particular the optical arms Bₙ). Some or all of these optical fibers may in particular be polarization-maintaining fibers (PMFs). Advantageously, the transmitting means 142-i1 and 142-12 (between the optical selector 142 and the signal-integrating units 144-1 and 144-2) shown in FIGS. 2, 3 and 4 may be polarization-maintaining fibers (PMFs). The transmitting means 144-i1 and 146-i1 of the optical arm B₁ shown in FIGS. 3 and 4 may also be PMFs.

In certain embodiments, the input transmitting means 140-i0, 140-i1 and 140-i2 for transmitting the optical signals generated by the signal generator 120 to the polarization encoder 140 shown in FIGS. 2, 3 and 4 may be single-mode optical fibers (SMFs) and/or PMFs. The output transmitting means 148-10 for transmitting the multiplexed signal S₁ from the polarization encoder 140 may be a single-mode optical fiber (SMF).

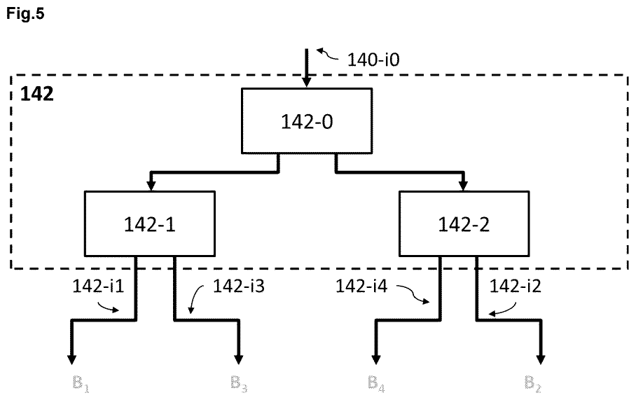

FIG. 5 schematically shows an optical selector 142 of a polarization encoder 140 comprising four optical arms B₁, B₂, B₃ and B₄, according to embodiments of the invention. In this case, the optical selector 142 may comprise a set of intermediate optical selectors (142-0, 142-1 and 142-2) configured to receive the initial quantum signal S_{Q0} and to pass it to a specific optical path. Each intermediate optical selector may be individually controlled by a sub-command signal (S_{C14-0}, S_{C14-1} and S_{C14-2}) defined for example based on the command signal S_{C14} for controlling the optical selector 142.

It will be noted that an encoder 140 may be configured to polarization encode the initial quantum signal S_{Q0} on two different and non-orthogonal polarization bases, as illustrated in FIG. 4, namely:
a first basis corresponding in particular to the polarization-encoding values P₁ and P₃ of the two optical arms B₁ and B₃ (formed by a first intermediate optical selector 142-1 and joined by a first intermediate optical recombiner 148-1), such as for example the diagonal basis (D/A), and
a second basis corresponding in particular to the polarization-encoding values P₂ and P₄ of the two optical arms B₂ and B₄ (formed by a second intermediate optical selector 142-2 and joined by a second intermediate optical recombiner 148-2), such as for example the rectilinear basis (H/V).

Such an encoder therefore makes it possible to generate four distinct encoding states, H, V, D and A, and to use these four states to apply the QKD protocol called BB84 (as described in the article “Quantum cryptography: Public key distribution and coin tossing” by C. Bennett and G. Brassard, 1984, Theoretical Computer Science, vol. 560, 1984, p. 7-11).

Moreover, it will be noted that an encoder 140 may be configured to polarization encode the initial quantum signal S_{Q0} only on two different polarization states, as illustrated in FIGS. 2 and 3. In this embodiment, the encoder 140 comprises only two encoding optical arms, each of its states being likeable to an encoding basis, called the ‘simplified basis’, for the sake of simplicity. The two simplified bases may advantageously be non-orthogonal. In this case, a first simplified basis may for example correspond to the polarization-encoding value P₁ of the optical arm B₁, and for example correspond to a linear polarization of type D (or A), whereas a second simplified basis may for example correspond to the encoding value P₂ of the optical arm B₂ and for example correspond to a linear polarization of type H (or V).

Advantageously, the first control signal R₁₁ of the first polarization-encoding value P₁ may correspond to the control signal of the first polarization-encoding basis (for example, the basis D/A or another simplified basis). Similarly, the second control signal R₁₂ of the second polarization-encoding value P₂ may correspond to the control signal of the second polarization-encoding basis (for example, the basis H/V or another simplified basis).

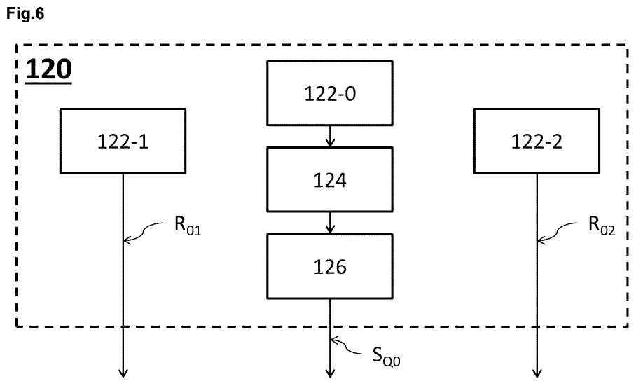

In embodiments, the multiplexed signal S₁ may be frequency-division multiplexed. In this case, the signal generator 120 (also called the ‘signal-generating module’) of the transmitter 10 may be configured to generate an initial quantum signal S_{Q0} of wavelength denoted λ_{Q}, a first reference signal R₀₁ of wavelength denoted λ_{R1} and a second reference signal R₀₂ of wavelength denoted λ_{R2}, these three wavelengths being different from one another. FIG. 6 schematically shows such a signal generator 120, according to embodiments of the invention.

Advantageously, the signal generator 120 may comprise a first laser source 122-0 emitting a laser beam of wavelength 2Q (equivalent to a frequency ω_{Q}). The emission wavelength No of the laser (also called the ‘quantum wavelength’) may be located in the visible or infrared. For example and non-limitingly, the first laser source 122-0 may be a DFB laser diode (DFB being the acronym of distributed feedback) using a Bragg grating allowing the emission wavelength Ao to be chosen. The chosen emission wavelength λ_{Q} of the laser diode may be equal to 1550 nm, for example. Such a laser diode in particular emits a continuous-wave laser beam. Alternatively, the first laser source 122-0 may be a pulsed laser unit, i.e. a gain-switched laser unit.

The signal generator 120 may also comprise two other additional laser sources 122-1 and 122-2, as shown in FIG. 6, configured to emit a laser beam of wavelength λR₁ (equivalent to a frequency ω_{R1}) and a laser beam of wavelength λ_{R2} (equivalent to a frequency ω_{R2}), respectively. The wavelengths λ_{R1} and λ_{R2} of laser emission (also called the ‘reference wavelengths’) may be located in the visible or infrared. For example and non-limitingly, the additional laser sources 122-1 and 122-2 may be DFB laser diodes or gain-switched laser units.

In embodiments, the frequency difference between the quantum wavelength λ_{Q} and a reference wavelength (λ_{R1} and/or λ_{R2}) may be greater than or equal to a first minimum wavelength-difference value δλ, according to the following inequality (01):

$$\vert {λ}_{Q} - {λ}_{R 1 / R 2} \vert \geq δλ \qquad ( 01 )$$

Moreover, the frequency difference between the reference wavelengths (λ_{R1} and/or λ_{R2}) of each of the reference signals R₀₁ and R₀₂ may be greater than or equal to a second minimum wavelength-difference value δλ′, according to the following inequality (02):

$$\vert {λ}_{R 1} - {λ}_{R 2} \vert \geq δ {λ}^{′} \qquad ( 02 )$$

Advantageously, the first minimum wavelength-difference value δλ and the second minimum wavelength-difference value δλ′ may be predefined and equal, for example and non-limitingly, to 1.6 nm and 0.8 nm, respectively.

According to certain embodiments, the signal-generating module 120 may further comprise one or more intensity-modulating units 124 configured to modulate the intensity of the laser pulses output by the first laser source 122-0 and to form quantum pulses. Such a unit may be used to implement a secure decoy-state QKD protocol.

The intensity-modulating unit 124 may also be configured to modulate the rate of the laser pulses, which will be of the order of a few kilohertz to a few tens of gigahertz for example, and/or the temporal width of the laser pulses, which will for example be up to a few nanoseconds.

In embodiments where the first laser source 122-0 is continuous-wave, the signal generator 120 may comprise a phase-modifying unit 126 configured to modify the phase of each of the quantum pulses. Advantageously, the phase-modifying unit may be configured to randomize (i.e. make random) the phase of each of these quantum pulses, so that the phases of two consecutive quantum pulses are independent of each other.

Phase randomization via use of a pulsed laser unit and/or a phase-modifying unit makes it possible to defend against certain attacks based on quantum key interception that may be performed by a spy device, conventionally called ‘Eve’, placed on the transmission channel 50 and seeking to intercept the multiplexed signal S₁ (and therefore the polarization-encoded quantum signal S_{Q1}), transmitted by the transmitter 10 ‘Alice’ and taking into account the phase coherence between quantum pulses.

In embodiments where the multiplexed signal S₁ is frequency-division multiplexed (i.e. when the quantum and reference wavelengths λQ, and λ_{R1} and λ_{R2} are different from one another) the signal-integrating units 144-1 and 144-2 of the polarization encoder 140 may be WDM units (WDM standing for wavelength-division multiplexing) configured to combine the passed initial quantum signal S_{Q0} and one of the reference signals R₀₁ or R₀₂ on a given optical path into a resultant signal.

In embodiments, the multiplexed signal S₁ may be time-division multiplexed. In this case, the multiplexed signal S₁ may be a signal comprising a set of three temporally distinct pulses, the set being repeated with a period T, the three pulses corresponding to the polarization-encoded quantum signal S_{Q1}, to the first control signal R₁₁ and to the second control signal R₁₂, respectively.

Advantageously, the initial quantum signal S_{Q0} and the reference signals R₀₁ and R₀₂ generated by the signal generator 120 may be pulsed signals characterized by a period T identical to the period of the multiplexed signal S₁.

In embodiments, the signal generator 120 may be configured to generate the initial quantum signal S_{Q0} and the reference signals R₀₁ and R₀₂ with a predefined time shift between each pulse of the signals. Alternatively (or furthermore), the signal-integrating units 144-1 and 144-2 of the polarization encoder 140 may be configured to apply a predefined time shift so as to obtain time-division multiplexed signal pulses.

The resulting time difference between each of the successive distinct pulses may thus be strictly less than the repetition period T of the resulting multiplexed signal S₁ (or of the initial quantum signal S_{Q0}), according to the following inequalities (03) and (04):

$$\vert {t}_{Q} - {t}_{R 1 / R 2} \vert < T \qquad ( 03 )$$

$$\vert {t}_{R 1} - {t}_{R 2} \vert < T \qquad ( 04 )$$

In these embodiments where the multiplexed signal S₁ is time-division multiplexed, the quantum and reference wavelengths λ_{Q}, and λ_{R1} and/or λ_{R2} may be equal to one another.

In this case, the additional laser sources 122-1 and 122-2 may for example be assimilated into the first laser source 122-0 and the signal generator 120 may further comprise a beam-splitting unit (not shown in the figures) configured to deliver two signal components associated with the reference signals R₀₁ and R₀₂, and another signal component associated with the initial quantum signal S_{Q0}. Such a beam-splitting unit may comprise one or more symmetrical or asymmetrical optical couplers, polarization-maintaining optical couplers for example. The beam-splitting unit may further be an optical selector generating a predefined time shift between each signal component delivered.

In embodiments, the beam-splitting unit of the signal generator 120 may be placed at the output of the first laser source 122-0, the resulting reference signals R₀₁ and R₀₂ then corresponding to conventional light pulses (i.e. non-quantum signals). Alternatively, the beam-splitting unit may be placed at the output of one of the additional quantum-signal-generating units (124, 126), the resultant reference signals R₀₁ and R₀₂ then corresponding to signals of low light intensities and/or to quantum signals.

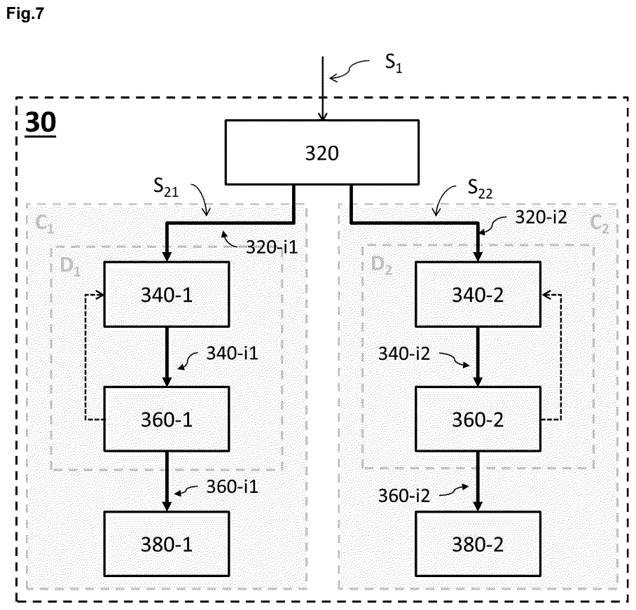

FIGS. 7, 8 and 9 schematically show the receiver 30, according to embodiments. In these embodiments, the receiver comprises a beamsplitter 320 and two processing chains C₁ and C₂.

The beamsplitter 320 (also called the ‘beam-splitting unit’) is configured to split the multiplexed signal S₁ transmitted by the transmitter 10 into two signal components, denoted S₂₁ and S₂₂, each signal component thus obtained traversing one of the two processing chains C₁ and C₂, respectively. In the remainder of the description and in the figures, the index ‘x’ is the index associated with one of the two processing chains of the receiver 30 and may be an integer equal to 1 or 2. The two processing chains C₁ or C₂ are thus generally designated by the notation Cₓ.

In embodiments, the beamsplitter 320 may be a symmetrical optical coupler (for example a 50/50 fiber-optic Y-coupler) that is for example placed at the input of the receiver 30. Such an optical coupler may in particular be a polarization-maintaining coupler. The beamsplitter 320 may thus be configured to deliver two signal components S₂₁ and S₂₂ of the multiplexed signal S₁, of pulses of equal intensity, each composed of 50% of the optical power of the first control signal R₁₁ of the first polarization-encoding value P₁, and 50% of the optical power of the second control signal R₁₂ of the second polarization-encoding value P₂.

Moreover, the signal S_{Q1} being a quantum signal, the beamsplitter 320 is configured to pass (or route) the polarization-encoded quantum signal S_{Q1} obtained from the multiplexed signal S₁ to one of the two processing chains Cₓ (i.e. C₁ or C₂) of the receiver 30.

Each processing chain Cₓ comprises a detecting module (generally denoted 380-x, such as the detecting modules 380-1 or 380-2) configured to measure the quantum signal S_{Q1} in at least one polarization state defined in a predefined polarization basis (a ‘polarization encoding basis’ in the transmitter 10, or a polarization decoding basis' in the receiver 30). Each processing chain Cₓ also comprises a correcting device, generally denoted Dₓ (such as D₁ or D₂ in FIG. 7), configured to determine the polarization state of the control signal associated with the polarization basis of the chain in question. The correcting device Dₓ is further capable of correcting the polarization state of the constituent signals of the component S₂ₓ (and in particular of the quantum signal S_{Q1}) traversing the processing chain Cₓ, in light of the determined polarization state of the control signal, so as to align this corrected polarization state with a polarization state (in particular Pₓ) of the detection polarization basis of the quantum signal defined beforehand by the detecting module 380-x.

As used here, the expression ‘alignment of a polarization state with a polarization basis’ refers to a rotation of the polarization state of a signal so that it corresponds to a specific detection axis of the basis determined by a piece of equipment for detecting the quantum signal.

By way of illustration, the processing chain C₁ may be associated with signal processing in the basis determined by the polarization P₁ (or by the polarizations P₁ and P₃, defined for example and non-limitingly in the diagonal basis D/A) and the processing chain C₂ may be associated with signal processing in the basis determined by the polarization P₂ (or by the polarizations P₂ and P₄, defined for example and non-limitingly in the rectilinear H/V basis).

Thus, for each processing chain Cₓ, the correcting device Dₓ may comprise a servo-control loop between a module for correcting polarization state and a module 360-x for detecting a control signal R₁ₓ.

A correcting module of the receiver 30 may be configured to modify the polarization of a signal traversing it, in response to a setpoint signal. Such a setpoint signal may be an electrical or radio-frequency signal, for example. Advantageously, a correcting module of the receiver 30 may be a fiber-optic polarization controller in particular comprising one or more polarization-rotating fibers the stress axis or axes of which (which are configured to rotate the polarization of the signal) are controlled (or adjusted) based on the setpoint signal. For example and non-limitingly, such a controllable stress axis may take the form of a wound fiber component of adjustable geometry, or employ a piezoelectric element inducing mechanical stresses in a fiber. Alternatively, a correcting module may comprise one or more so-called active waveplates, i.e. waveplates the plate rotation of which (i.e. of its optical axis) is controlled (or adjusted) depending on the setpoint signal.

In embodiments, the receiver 30 may comprise two separate correcting modules, 340-1 and 340-2 (generally denoted 340-x), each module being associated with the correction of the polarization of the signals traversing it. In particular, a correcting module 340-x may be arranged to correct the polarization of the constituent signals of the component S₂ₓ associated with the correcting device Dₓ (depending on the specific polarization state Pₓ for example). Alternatively, the receiver 30 may comprise a single correcting module 340-0 arranged to simultaneously correct the polarization of the constituent signals of the component S₂₁ of the correcting device D₁ and the polarization of the constituent signals of the component S₂₂ of the correcting device D₂ (depending on the respective polarization states P₁ and P₂ for example)

For each processing chain Cₓ, a correcting module (340-x or 340-0) may be arranged upstream of the detecting module 360-x, and the detecting module 360-x may be arranged downstream of the beamsplitter 320.

In embodiments, the two correcting modules 340-1 and 340-2 of the two processing chains of the receiver may be positioned downstream of the beamsplitter 320, as shown in FIG. 7.

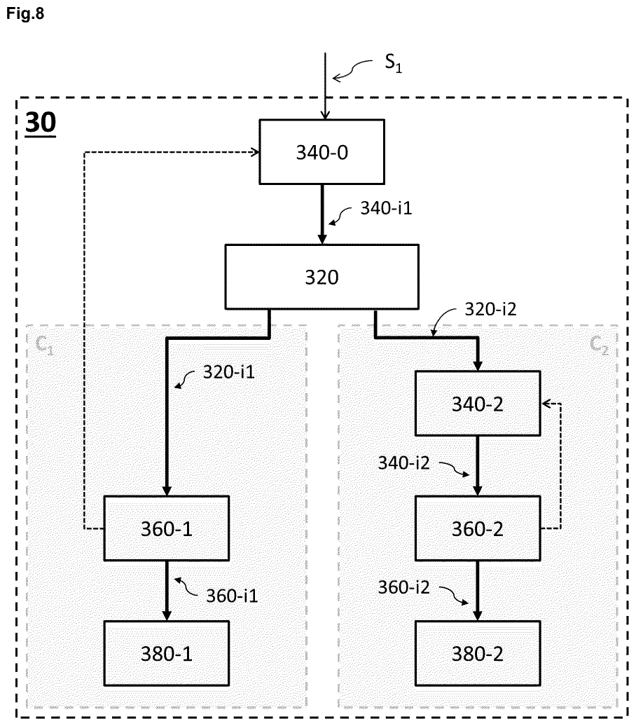

In certain embodiments, one of the two correcting modules 340-1 (or 340-2) of the corresponding correcting device D₁ (or D₂, respectively) may be positioned upstream of the beamsplitter 320, whereas the other correcting module 340-2 (or 340-1, respectively) may be positioned downstream of the beamsplitter 320, as shown in FIG. 8.

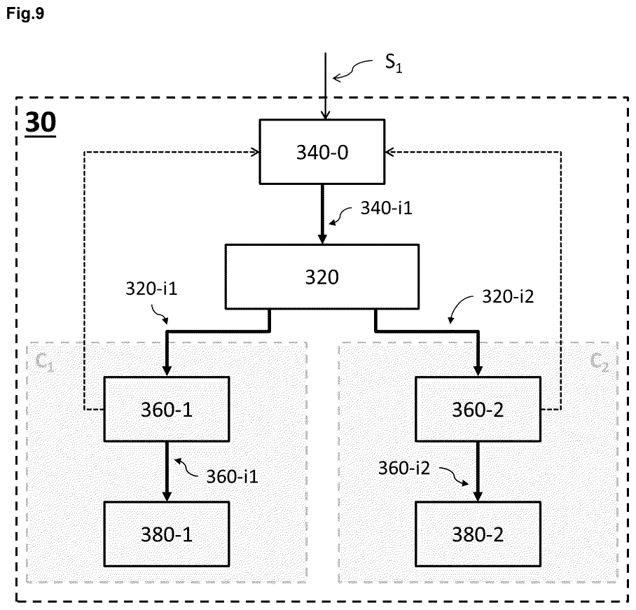

In embodiments where the receiver 30 comprises a single correcting module 340-0, associated with the two correcting devices D₁ and D₂, the module may be positioned upstream of the beamsplitter 320, as shown in FIG. 9. In this case, the correcting module 340-0 may be a triplet of active waveplates comprising, in succession, a quarter-wave plate, a half-wave plate and a quarter-wave plate. In this case also, the beamsplitter 320 may further comprise a so-called passive waveplate at the output of the coupler, the plate being positioned on one of the optical channels of the coupler conveying one of the two signal components S₂₁ or S₂₂ obtained from the multiplexed signal S₁.

The transmitting means 320-ix at the output of the beamsplitter 320 and the transmitting means 340-ix at the output of the polarization-correcting units 340-x may be SMFs. Advantageously, these transmitting means may be PMFs.

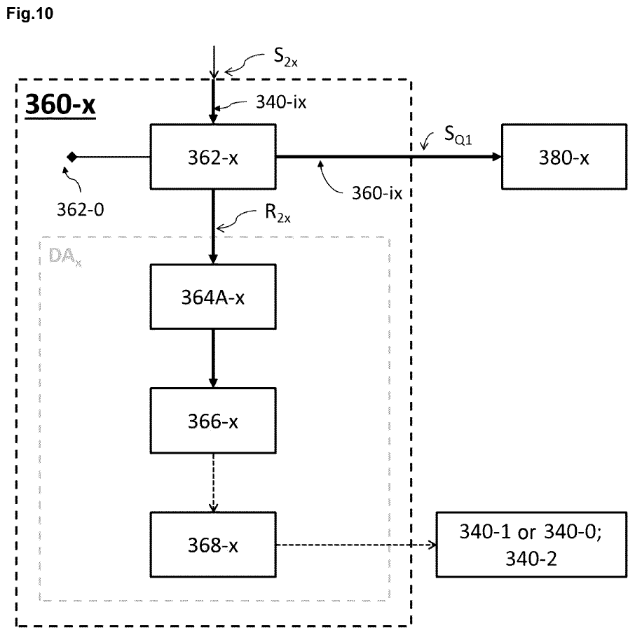

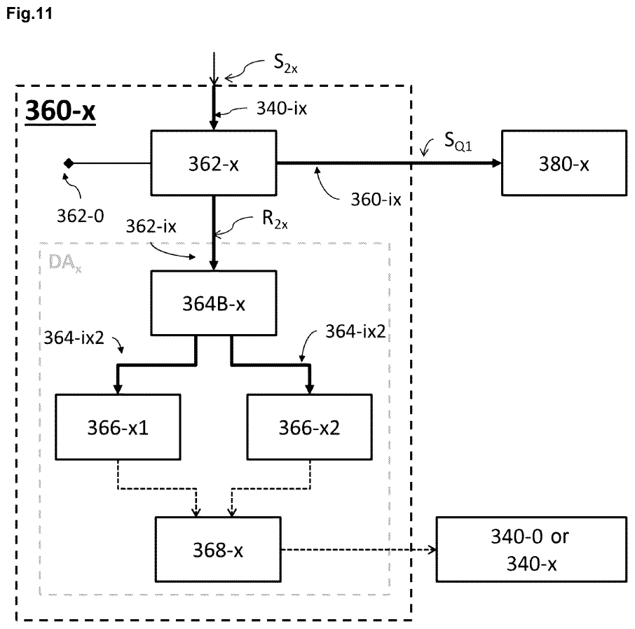

FIGS. 10 and 11 schematically show a detecting module 360-x for detecting a control signal R₁ₓ comprising a signal-demultiplexing unit 362-x and a polarization-analyzing device DAₓ for analyzing the polarization of the integrated control signal R₁ₓ, according to embodiments of the invention.

The signal-demultiplexing unit 362-x (i.e. 362-1 or 362-2) receives as input the signal component S₂ₓ obtained from the multiplexed signal S₁ at the output of the correcting module 340-x and/or the beamsplitter 320. The demultiplexing unit 362-x may be configured to split, from the signal Sex, the quantum signal S_{Q1}, the component denoted R₁₁ of the first control signal R₁₁ and the component denoted R₂₁ of the second control signal R₁₂. The quantum signal Sot demultiplexed from the signal S₂ₓ at the output of the unit 362-x is then routed to the detecting module 380-x of the processing chain Cₓ. One of the two components of the control signal, denoted R₂ₓ (R₂₁ or R₂₂), is then processed by the chain Cₓ, while the other component of the control signal (R₂₂ or R₂₁, respectively) is not used (for example and non-limitingly, such a component may then be passed to a beam absorber 362-0 as shown in FIGS. 10 and 11).

The signal-demultiplexing unit 362-x may in particular comprise one or more demultiplexing elements determined depending on the type of multiplexing used to multiplex the signal S₁, i.e. on whether it is a question of frequency- and/or time-division multiplexing.

In embodiments where the multiplexed signal S₁ is frequency-division multiplexed, the signal-demultiplexing unit 362-x may comprise a first filter F₁ configured to split the quantum signal Sot from the two integrated control-signal components (R₂₁ and R₂₂), and a second filter F₂ configured to split the two integrated control-signal components (R₂₁ and R₂₂) from each other. For example, and non-limitingly, such filters may be band-stop filters such as FBG filters (FBG standing for fiber Bragg grating) or a WDM add/drop filter. The first filter F₁ may be selected depending on the predetermined frequency difference between the quantum wavelength λ_{Q} and the reference wavelengths (λ_{R1} and/or λ_{R2}), which is for example defined by equation (01). Similarly, the second filter F₂ may be selected depending on the predetermined frequency difference between the reference wavelengths (λ_{R1} and/or λR₂) of each of the reference signals R₀₁ and R₀₂, which is for example defined by equation (02).

The transmitting means 360-ix and 362-ix at the output of the signal-demultiplexing unit 362-x, which transmit to the detecting module 380-x and the analyzing device DAₓ, respectively, and the transmitting means included in the unit 362-x (which have not been shown in the figures), may be SMFs. Advantageously, these transmitting means may be PMFs.

One device DAₓ (i.e. DA₁ or DA₂) for analyzing the polarization of the control signal R₁ₓ may be configured to detect the control-signal component R₂ₓ to be processed by the chain Cₓ, in a predefined polarization basis, so as to deliver the estimated control signal R₃ₓ (i.e., R₃₁ or R₃₂).

It will be noted that at the output of the transmitter 10, the control signal R₁ₓ is generated in the transmitter 10 in a well-defined polarization state Pₙ. During propagation of the signal between the transmitter 10 and the receiver 30, the polarization state of the control signal R₁ₓ may have undergone random rotations, and hence the polarization state of the control-signal component R₂ₓ, relative to the control signal R₁ₓ, detected by the receiver 30 may be different from the initially defined polarization state Pₙ.

Thus, the device DAₓ for analyzing the polarization of the control signal R₁ₓ may comprise at least one detecting unit configured to detect signals, in particular signals with a predefined polarization, so as to deliver the estimate of the received control signal R₃ₓ (i.e. R₃₁ or R₃₂).

In embodiments, a detecting unit of the analyzing device DAₓ may be configured to detect conventional light pulses. For example and non-limitingly, such a unit may be a photodiode configured to deliver a photocurrent, depending on the measurement of the received control-signal component R₂ₓ associated with the processing chain Cₓ.

Alternatively, a detecting unit of the analyzing device DAₓ may be a single-photon detector. Such a detector may be composed of a detection surface configured to detect the “presence” of single photons at its detection surface (i.e. via photon/surface interaction). This detection of the presence of single photons is defined in terms of a given quantum detection efficiency. For example and non-limitingly, the single-photon detector may be an avalanche photodiode (APD) or even a superconducting nanowire single-photon detector (SNSPD). In particular, the single-photon detector may comprise an internal amplification mechanism configured to deliver a voltage, when a photon is detected.

In certain embodiments, the analyzing device DAₓ may comprise a polarizer 364A-x and a single detecting unit 366-x for detecting the control signal R₁ₓ, as shown in FIG. 10. The polarizer 364A-x (also called the ‘polarizing filter’) may be arranged to transmit, to the detecting unit 366-x, only optical signals defined in the polarization state Pₓ. The associated detecting unit 366-x is thus configured to detect radiant energy relative to the integrated control-signal component R₂ₓ defined in the polarization state Pₓ only, to deliver the estimate of the received control signal R₃ₓ. In this configuration, the value of the control signal R₃ₓ detected (or measured) by the detecting unit 366-x is maximum if the polarization state of the control-signal component R₂ₓ is equal to the polarization state Pₓ of the control signal R₁ₓ. Conversely, the value of the control signal R₃ₓ is minimum if the polarization state of the control-signal component R₂ₓ is orthogonal to the polarization state Pₓ of the control signal R₁ₓ.

Advantageously, the analyzing device DAₓ may comprise a polarizing, detecting unit having both (i.e. combining) the functionality of the polarizer 364A-x and the functionality of the detecting unit 366-x.

In embodiments, the analyzing device DAₓ may comprise a polarizing beamsplitter 364B-x, followed by two detecting units 366-x1 and 366-x2, as shown in FIG. 11. The polarizing beamsplitter 364B-x (also called the ‘polarizing splitter’) is configured to deliver two polarized signal sub-components of the control-signal component R₂ₓ, each sub-component propagating over one transmitting means (364-ix1 or 364-ix2) on output from the splitting unit 364B-x to one of the detecting units (366-x1 or 366-x2), and being defined only in one of the two predefined polarization states of the polarization basis processed by the processing chain Cₓ and in particular comprising the polarization state Pₓ. Each detecting unit (366-x1 and 366-x2) is thus configured to detect radiant energy relative to one of the two polarized sub-components, to deliver the estimated control signal R₃ₓ. For example and non-limitingly, in this configuration, the value relative to the estimated control signal R₃ₓ measured by the first detecting unit 366-x1 may be maximum, and the value relative to the integrated signal R₃ₓ measured by the second detecting unit 366-x2 may be minimum if the polarization state of the control-signal component R₂ₓ is equal to the polarization state Pₓ of the control signal R₁ₓ. Conversely, the value relative to the estimated control signal R₃ₓ measured by the detecting unit 366-x may be minimum, and the value relative to the estimated control signal R₃ₓ measured by the second detecting unit 366-x2 may be maximum if the polarization state of the control-signal component R₂ₓ is orthogonal to the polarization state Pₓ of the control signal R₁ₓ.

For example, for the processing chain C₁, the device DA₁ for analyzing the polarization of the received control-signal component R₂₁ associated with the diagonal basis (D/A) may comprise a splitting unit 364B-1 configured to deliver a first sub-component having a linear polarization P₁, of type D, i.e. a diagonal polarization, which propagates over the transmitting means 364-i11, and a second sub-component having a linear polarization P₃, of type A, i.e. an anti-diagonal polarization, which propagates over the transmitting means 364-i12. In this example, the two corresponding detecting units 366-11 and 366-12 are therefore configured to detect the sub-component relative to the linear polarization P₁ of the received control-signal component R₂₁ and the sub-component relative to the linear polarization P₃ of the received control-signal component R₂₁, respectively.

In certain embodiments, the one or more detecting units (366-x, or 366-x1 and 366-x2) of the processing chain Cₓ may be configured to the reference wavelength λ_{Rx} (i.e. λR₁ Or λ_{R2}) of the control-signal component R₂ₓ to be detected.

The receiver 30 may further comprise one or more processors (also called ‘system units’) or CPUs (acronym of central processing unit).

In embodiments, each analyzing device DAₓ may comprise a specific processor, generally denoted 368-x (i.e. 368-1 and 368-2) configured to analyze the one or more electrical signals delivered by the one or more detecting units (366-x, or 366-x1 and 366-x2) and corresponding to the estimated control signal R₃ₓ. A processor 368-x may be configured to generate a servo-control signal, denoted S_{C36-x}, corresponding to a polarization-correcting setpoint signal to be delivered to the correcting module 340-x associated with the processing chain DAₓ.

In certain embodiments, the receiver 30 may comprise a single processor 368, configured to analyze all of the electrical signals delivered by the detecting units of the analyzing devices DA₁ and DA₂, which correspond to the estimated control signals R₃₁ and R₃₂. The processor 368 may be configured to generate one or more servo-control signals, S_{C36} or S_{C36-x}. A servo-control signal S_{C36} generated by the single processor 368 may correspond, for example, to the polarization-correcting setpoint signal to be delivered to the single correcting module 340-0.

A servo-control loop associated with one or both correcting devices (i.e. a polarization-correcting loop generating a servo-control signal) may be implemented continuously or intermittently. A processor (368-x or 368) may thus be configured to control the one or more servo-control loops of the receiver 30. In particular, a servo-control loop may be activated periodically and/or after evaluation of the polarization state of one or both of the control signals estimated with respect to one or more polarization states of one or more associated polarization bases. Moreover, a servo-control loop may be implemented until the polarization state of one or both estimated control signals is aligned with the associated selected (or reference) polarization state.

In embodiments, a processor of the receiver 30 may be configured to determine, for a specific correcting device Dₓ, a value of the difference in polarization state δPₓ between the polarization state of the estimated control signal R₃ₓ and the polarization state Pₓ of the associated polarization basis. The processor may further be configured to evaluate whether this value of the difference in polarization state δPₓ is strictly greater than (or greater than or equal to) a predefined reference difference value δP_{ref}.

In particular, a servo-control loop may be activated if a determined value of the difference in polarization state δPₓ is greater than or equal to the reference difference value δP_{ref}.

Advantageously, a servo-control loop may be implemented so as to optimize (i.e. maximize or minimize) detection of the component of the control signal(s), depending on the associated polarization state(s).

For example and non-limitingly, a servo-control signal of a servo-control loop may be generated using a differentiable optimization algorithm, such as a gradient descent algorithm, so as to search (incrementally or iteratively) for an optimum point of an objective function associated in particular with the one or more values of the difference in polarization state of one correcting device Dₓ or of both correcting devices of the receiver. If an optimum point is found, the servo-control loop may be stopped.

The servo-control loop may also be stopped, for example and non-limitingly, if a determined value of the difference in polarization state δPₓ is strictly less than (or less than or equal to) the reference difference value δP_{ref}.

Thus, in embodiments, a servo-control signal S_{C36-x} relative to the setpoint signal of a correcting module 340-x may be generated with a view to controlling said module 340-x, and in particular of rotating the polarization of the signal component S₂ₓ until the value of the estimated control signal R₃ₓ, measured by the detecting unit 366-x (or the first detecting unit 366-x1), is optimal, i.e. the polarization state of the control-signal component R₂ₓ is then equal or orthogonal to the polarization state Pₓ of the control signal R₁ₓ. Modification of the polarization of the signal component S₂ₓ via the servo-control signal S_{C36-x} thus induces a modification of the polarization state of the quantum signal S_{Q1} (demultiplexed from the signal S₂ₓ) output by the unit 362-x and routed to the detecting module 380-x of the processing chain Cₓ.

In certain embodiments, a servo-control signal S_{C36} relative to a setpoint signal to be delivered to the single correcting module 340-0 may be generated with a view to controlling said module 340-0 and in particular to rotating the polarization of the two signal components S₂₁ and S₂₂ until the two estimated control-signal values R₃₁ and R₃₂, measured by the detecting units 366-1 and 366-2 (or the first detecting units 366-11 and 366-21), are optimal, i.e. the polarization states of the control-signal components R₂₁ and R₂₂ are equal to the polarization states P₁ and P₂ of the control signals R₁₁ and R₁₂ (or orthogonal to them), respectively.

For each processing chain Cₓ, the module 380-x for detecting the quantum signal comprises at least one single-photon detector. Detecting the polarization-encoded quantum signal S_{Q1} by means of the set of photon-detecting units of the processing chains (i.e. C₁ and C₂) of the receiver 30 makes it possible to deliver the estimated received quantum signal S_{Q3} and thus an estimate of how the quantum signal is polarization-encoded with the predetermined encoding states.

In certain embodiments, such as for example in embodiments where the quantum signal S_{Q1} is encoded with a set of [symbol] only two possible polarization states, P₁ or P₂ (i.e. defined in a simplified polarization basis), the module 380-x for detecting the quantum signal of a processing chain Cₓ may comprise a single single-photon detector 386-x configured to detect the quantum signal S_{Q1} defined in said polarization state Pₓ.

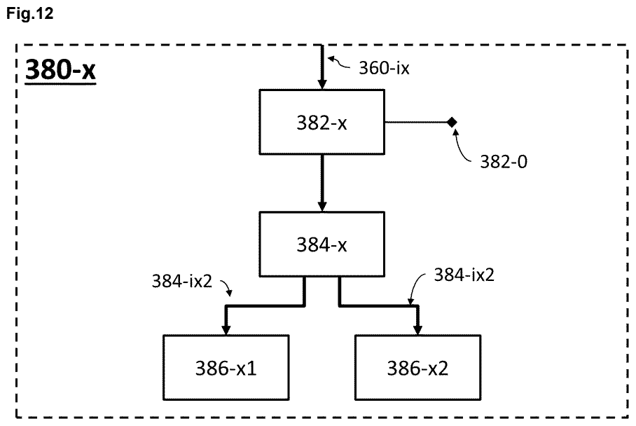

In other embodiments, as in cases where the quantum signal S_{Q1} is encoded with a set of [symbol] four possible polarization states, P₁, P₂, P₃ or P₄ (i.e. defined in the polarization bases D/A and H/V for example), the module 380-x for detecting the quantum signal may comprise a switching unit 384-x, preceded by two single-photon detectors 386-x1 and 386-x2, as shown in FIG. 12. The switching unit 384-x may be assimilated into the polarizing beamsplitter 364B-x of the analyzing device DAₓ. The switching unit 384-x may therefore be configured to pass (i.e. route or switch) the quantum signal S_{Q1} demultiplexed from the signal S₂ₓ to one of the two single-photon detectors (386-x1 or 386-x2) depending on the polarization state of the quantum signal. Each single-photon detector (386-x1 and 386-x2) is thus arranged to detect the presence of defined single photons in one of the predefined polarization states of the polarization basis processed by the processing chain Cₓ, said basis in particular comprising the polarization state Pₓ.

By way of illustration, in respect of processing chain C₁, the module 380-1 for detecting the quantum signal associated, for example and non-limitingly, with the diagonal basis D/A, may comprise the switching unit 384-1 arranged to pass the quantum signal S_{Q1} having a linear polarization P₁, of diagonal type D, to a first single-photon detector 386-11 via the transmitting means 384-i11, or to pass the quantum signal S_{Q1} having a linear polarization P₃, of anti-diagonal type A, to a second single-photon detector 386-12 via the transmitting means 384-i12. Equivalently, in respect of processing chain C₂, the module 380-2 for detecting the quantum signal associated, for example, with the diagonal basis H/V, may comprise the switching unit 384-2 arranged to pass the quantum signal S_{Q1} having a linear polarization P₂, of horizontal type H, to the single-photon detector 386-21 via the transmitting means 384-i21, or to pass the quantum signal S_{Q1} having a linear polarization P₄, of vertical type V, to the single-photon detector 386-22 via the transmitting means 384-i22.

In embodiments, the module 380-x for detecting the quantum signal may comprise, at its input, an additional demultiplexing unit 382-x, likeable to the signal-demultiplexing unit 362-x of the detecting module 360-x, and configured to transmit the quantum signal S_{Q1} to the single-photon detector 386-x, or to the switching unit 384-x, as shown in FIG. 12. The residual components of the control signals are then passed to a beam absorber 382-0, as shown in FIG. 12.

The additional demultiplexing unit 382-x of the module 380-x may in particular comprise a demultiplexing element determined depending on the type of multiplexing used to multiplex the signal S₁. For example, in the case of frequency-division multiplexing, the additional demultiplexing unit 382-x may be a spectral filter configured to split the quantum signal S_{Q1} from the two residual components of the integrated signals, i.e. a filter such as an FBG filter or a WDM add/drop filter, selected depending on the predetermined frequency difference between the quantum wavelength λQ and the reference wavelengths (λ_{R1} and/or λR₂).

Such an additional demultiplexing unit 382-x in particular makes it possible to increase the filtering capacity of the control signals R₁₁ and R₁₂, in order to improve the quantum measurement performed by the module 380-x for detecting the quantum signal.

In embodiments, for example in embodiments where the control signals R₁₁ and R₁₂ are quantum signals and where the multiplexed signal S₁ may be time-division multiplexed, a correcting device Dₓ may comprise a module for correcting polarization state and a module 380-x for detecting the quantum signal. In this case, the module 380-x for detecting the quantum signal may be configured to detect the quantum signal S_{Q1}, and the control signal R₁ₓ associated with the correcting device Dₓ. Such a module 380-x may then comprise a switching unit 384-x corresponding to a polarizing beamsplitter, at least one single-photon detector 386-x and a processor (equivalent to a systems unit 368-x or 368) configured to generate the one or more servo-control signals corresponding to the polarization-correcting setpoint signals to be delivered to the one or more associated correcting modules.

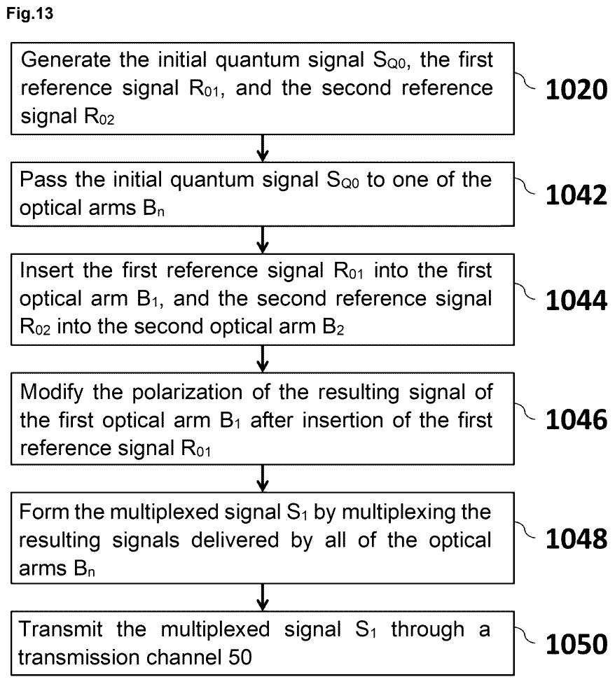

FIG. 13 shows the method for transmitting a multiplexed signal S₁ implemented by the transmitter 10, according to embodiments of the invention.

The transmitting method comprises a preliminary step 1020 of generating an initial quantum signal S_{Q0}, and a first reference signal R₀₁, and a second reference signal R₀₂.

In step 1042, the initial quantum signal S_{Q0} is passed to one of the optical arms Bₙ of the transmitter 10.

In step 1044 (equivalent to two separate sub-steps 1044-1 and 1044-2), the first reference signal R₀₁ is inserted into a first optical arm B₁ and the second reference signal R₀₂ is inserted into a second optical arm B₂ among the optical arms of the transmitter 10.

In one of the inserting sub-steps 1044-1 or 1044-2, the first reference signal R₀₁ or the second reference signal R₀₂ may be multiplexed with the initial quantum signal S_{Q0}, depending on the routing of the initial quantum signal S_{Q0} to one of the optical arms Bₙ in step 1042.

In step 1046, a polarization modification is applied to the optical signal traversing the first optical arm B₁ (i.e. the result of multiplexing of the first reference signal R₀₁ and the initial quantum signal S_{Q0}, or only the first reference signal R₀₁, depending on the routing of the initial quantum signal S_{Q0}), this leading to encoding with a first polarization-encoding value P₁.

In step 1048, all the resulting signals delivered by the optical arms Bₙ of the transmitter 10 are recombined to form the multiplexed signal S₁ comprising:
a first control signal R₁₁ for controlling the first polarization-encoding value P₁ determined based on the first reference signal R₀₁ and delivered by the optical arm B₁,
a second control signal R₁₂ determined based on the second reference signal R₀₂ and delivered by the second optical arm B₂, the second signal R₁₂ corresponding to a control signal for controlling a second polarization-encoding value P₂ associated with the second optical arm B₂, and
a quantum signal S_{Q1} encoded with a polarization-encoding value defined among a set of values [symbol] comprising the first polarization-encoding value P₁ and the second polarization-encoding value P₂.

In step 1050, the multiplexed signal S₁ is transmitted through a transmission channel 50.

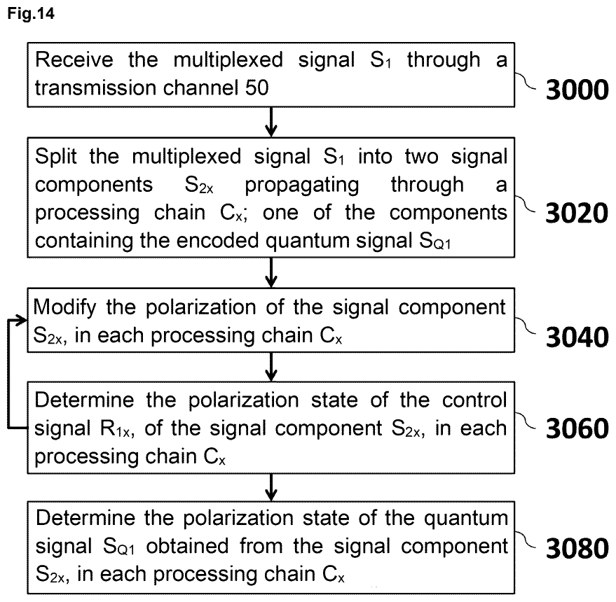

FIG. 14 shows the method for receiving a multiplexed signal S₁ implemented by the receiver 30, according to embodiments of the invention.

The receiving method comprises a preliminary step 3000 of receiving a multiplexed signal S₁ transmitted through a transmission channel 50.

In step 3020, the multiplexed signal S₁ is split into two signal components S₂₁ and S₂₂ (or S₂ₓ) each comprising one component of the first control signal R₁₁ and one component of the second control signal R₁₂, each signal component S₂ₓ propagating to one of the processing chains Cₓ of the receiver 30, respectively. Furthermore, an encoded quantum signal S_{Q1} contained in the multiplexed signal S₁ is passed to one of the processing chains Cₓ.

The receiving method further comprises, for each processing chain Cₓ associated with a predefined polarization basis, composed of at least the polarization state Pₓ, a servo-control loop between steps 3040 and 3060; step 3060 corresponds to determining the polarization state of a control signal R₁ₓ of the signal component S₂ₓ passing through the chain, and step 3040 corresponds to modifying the polarization of the signal component S₂ₓ. The servo-control loop between steps 3040 and 3060 is stopped when the polarization state determined in step 3060 is aligned with respect to one of the polarization states of the basis of the chain Cₓ.

In step 3080, the polarization state of the encoded quantum signal Sot of the signal component S₂ₓ passing through one of the processing chains Cₓ is determined.

Those skilled in the art will readily understand that certain steps of the transmitting and receiving method of FIGS. 13 and 14 may be carried out simultaneously, sequentially, independently or not, and/or in a different order, for example in an order defined by the transmitter and receiver, respectively.

The quantum system or the sub-systems of the system (transmitter and receiver), and the methods described above, according to the embodiments of the invention, may be implemented in various ways by hardware or a combination of hardware and software, and in particular in the form of program code that may be distributed as a program product, in various forms. The program code may be distributed using computer-readable media, which may include computer-readable storage media and communication media. The methods described in the present description may be implemented in particular in the form of computer program instructions able to be executed by one or more processors in a computer-based computing device. These computer program instructions may also be stored on a computer-readable medium.

The invention is not limited to the embodiments described above by way of non-limiting example. It encompasses any variant of embodiment envisionable by those skilled in the art.

1. A transmitter configured to transmit a multiplexed signal (S₁) through a transmission channel, wherein said transmitter comprises:
a signal generator configured to generate an initial quantum signal (S_{Q0}), a first reference signal (R₀₁) and a second reference signal (R₀₂),
a polarization encoder comprising a plurality of N optical channels (Bₙ), the polarization encoder further comprising:
an optical selector configured to select one of said optical channels (Bₙ) and to pass the generated initial quantum signal (S_{Q0}) to the selected optical channel (Bₙ),
an optical recombiner configured to generate said multiplexed signal (S₁), the multiplexed signal comprising a first signal (R₁₁) for controlling a first polarization-encoding value (P₁), a second signal (R₁₂) for controlling a second polarization-encoding value (P₂), and a quantum signal (S_{Q1}) encoded with one polarization-encoding value selected from a set of values ( [symbol] ) containing at least said first polarization-encoding value (P₁) and said second polarization-encoding value (P₂), said encoded quantum signal (S_{Q1}) being determined based on said initial quantum signal (S_{Q0}) delivered by the optical channel selected by said optical selector,
and in that the optical channels (Bₙ) comprise a first optical channel (B₁) comprising a first integrating unit configured to integrate said first reference signal (R₀₁) into the first optical channel (B₁) and a second optical channel (B₂) comprising a second integrating unit configured to integrate the second reference signal (R₀₂) into the second optical channel (B₂), said first control signal (R₁₁) being determined based on the first reference signal (R₀₁) delivered by the first optical channel (B₁) to the optical recombiner, and said second control signal (R₁₂) being determined based on said second reference signal (R₀₂) delivered by the second optical channel (B₂) to the optical recombiner.

2. The transmitter according to claim 1, wherein each optical channel (Bₙ) of said polarization encoder is associated with one polarization-encoding value (Pₙ) of said set of values ( [symbol] ), and wherein at least one of said optical channels (Bₙ) further comprises an optical element (146-n) configured to modify the polarization of an optical signal passing through said optical channel (Bₙ) depending on the associated encoding value (Pₙ).

3. The transmitter according to claim 1, wherein said transmitter is a guided all-optical device, said optical channels (Bₙ) of said polarization encoder being formed from polarization-maintaining fibers (PMFs) and/or integrated waveguides.

4. A receiver configured to receive a multiplexed signal (S₁) through a transmission channel, said multiplexed signal (S₁) comprising an encoded quantum signal (S_{Q1}), a first signal (R₁₁) for controlling a first polarization-encoding value (P₁) and a second signal (R₁₂) for controlling a second polarization-encoding value (P₂), wherein said receiver comprises a beamsplitter configured to split said multiplexed signal (S₁) into two signal components (S₂₁ and S₂₂) each comprising one component of said first control signal (R₁₁) and one component of said second control signal (R₁₂), each signal component (S₂₁; S₂₂) passing through a processing chain (C₁; C₂) associated with a polarization basis composed of at least one polarization state (P₁; P₂), respectively, one of said signal components (S₂₁ or S₂₂) further comprising said encoded quantum signal (S_{Q1}),
wherein each processing chain (C₁; C₂) comprises a correcting device (D₁; D₂) configured to determine the polarization state of an integrated control signal (R₁₁; R₁₂) of said signal component (S₂₁, S₂₂) passing through said chain, the correcting device (D₁; D₂) further being configured to modify the polarization of said signal component (S₂₁, S₂₂) so as to align said determined polarization state with respect to one of said at least one polarization state of said associated basis, each processing chain (C₁; C₂) comprising a detecting module configured to measure said encoded quantum signal (S_{Q1}) in at least one of said at least one polarization state of said associated basis.

5. The receiver according to claim 4, wherein, for each processing chain (C₁; C₂), said correcting device (D₁; D₂) is configured to demultiplex said signal component (S₂₁, S₂₂) with a view to selecting one of said control-signal components (R₁₁; R₁₂) and routing it to a polarization-analyzing device (DA₁; DA₂) comprising at least one detecting unit and configured to detect said selected component of the integrated control signal (R₁₁; R₁₂) in one of said at least one polarization state of said associated basis.

6. The receiver according to claim 4, wherein, in each processing chain (C₁; C₂), said correcting device (D₁; D₂) further comprises a processor (368-1; 368-2) configured to analyze said determined polarization state and to generate a servo-control signal (S_{C36}) applied to a module for correcting the polarization of said signal component (S₂₁, S₂₂).

7. The receiver according to claim 4, wherein said beamsplitter is a symmetrical fiber-optic 50/50 optical Y-coupler, and wherein said processing chains (C₁; C₂) are formed from polarization-maintaining fibers (PMFs) and/or single-mode optical fibers (SMFs).

8. A system for distributing quantum encryption keys, comprising a transmitter according to claim 1 and further comprising:
a receiver configured to receive a multiplexed signal (S₁) through a transmission channel, said multiplexed signal (S₁) comprising an encoded quantum signal (S_{Q1}), a first signal (R₁₁) for controlling a first polarization-encoding value (P₁) and a second signal (R₁₂) for controlling a second polarization-encoding value (P₂), wherein said receiver comprises a beamsplitter configured to split said multiplexed signal (S₁) into two signal components (S₂₁ and S₂₂) each comprising one component of said first control signal (R₁₁) and one component of said second control signal (R₁₂), each signal component (S₂₁; S₂₂) passing through a processing chain (C₁; C₂) associated with a polarization basis composed of at least one polarization state (P₁; P₂), respectively, one of said signal components (S₂₁ or S₂₂) further comprising said encoded quantum signal (S_{Q1}),
wherein each processing chain (C₁; C₂) comprises a correcting device (D₁; D₂) configured to determine the polarization state of an integrated control signal (R₁₁; R₁₂) of said signal component (S₂₁, S₂₂) passing through said chain, the correcting device (D₁; D₂) further being configured to modify the polarization of said signal component (S₂₁, S₂₂) so as to align said determined polarization state with respect to one of said at least one polarization state of said associated basis, each processing chain (C₁; C₂) comprising a detecting module configured to measure said encoded quantum signal (S_{Q1}) in at least one of said at least one polarization state of said associated basis.

9. The system according to claim 8, wherein said multiplexed signal (S₁) is a frequency-division multiplexed signal.

10. The system according to claim 9, wherein the absolute value of the wavelength difference between said encoded quantum signal (S_{Q1}) and said first and/or said second integrated signal (R₁₁ and/or R₁₂) is greater than or equal to a first minimum wavelength-difference value (δλ), and wherein the absolute value of the wavelength difference between said first control signal (R₁₁) and said second control signal (R₁₂) is greater than or equal to a second minimum wavelength-difference value (δλ′).
